(19) United States
(12) Patent Application Publication
(10) Pub. No.: US 2006/0059007 A1
(43) Pub. Date: Mar. 16, 2006

(54) Systems and methods for integrating course data

(76) Inventors: Hui-Chun Chen, Kaohsiung City (TW); Pai-Pin Wang, Kuanhsi Town (TW); Hung-Chang Chen, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/018,800

(22) Filed: Dec. 21, 2004

(30) Foreign Application Priority Data
Sep. 10, 2004 (TW) 93127442

(51) Int. Cl. G06Q 99/00

(52) U.S. Cl. 705/1

(57) ABSTRACT

A system and method for integrating course data is provided. A receiver comprises a computer and a mobile device. A server provides the receiver with at least one on-line course page, and transmits at least one mobile course page to the mobile device of the receiver via instant message or MMS (Multimedia Messaging Service). The on-line and mobile course pages are associated according to corresponding on-line course metadata and mobile course metadata.

### BACKGROUND

The present invention relates to computer network technology, and in particular, to a system and a method for integrating course data.

Many people take courses, such as English courses, through diverse media, such as books, and on-line via computer or mobile device.

A student can begin an on-line learning using a computer at any time. On-line courses are described by metadata and typically composed in a tree structure, each node of which is a specific course page comprising course data. Learners can study an on-line course by following the structure thereof. Mobile courses are typically sent in the form of messages to a mobile device, such as a mobile phone, enabling the learner to study anywhere. The messages of mobile courses comprise simple course content and are not of such a systematic structure as on-line courses.

Generally, on-line and mobile courses respectively have different data formats. Integration thereof may be realized by transforming mobile courses into course pages of on-line courses and linking the course pages and the on-line courses. The transformation of the mobiles courses, however, may consume system resources and present a consistency issues between course pages and messages. Additionally, on-line course pages with fixed links to mobile course pages lack flexibility for future use. Further, it is time-consuming to re-author on-line courses for the purposes of integration.

### SUMMARY

Systems for integrating course data are provided. An exemplary embodiment of systems for integrating course data comprises a receiver and a server. The receiver comprises a computer and a mobile device. The server provides at least one on-line course page to the receiver and, according to a schedule, transmits at least one mobile course page associated with the on-line course page in form of text messages or multimedia messaging service (MMS) messages to the mobile device.

The on-line course page may comprise an on-line course. The mobile course page may comprise a mobile course. The server displays the on-line course in a first region of an interface and a link referring to the mobile course in a second region of the interface. The server delivers the mobile course and plays the mobile course on the computer when the receiver selects the link via the computer.

The server further associates the on-line course with the mobile course based on on-line course metadata and mobile course metadata.

The on-line course may be a linguistic course, and the mobile course comprises at least a vocabulary word, a phrase, or a grammar concept mentioned in the linguistic course. The server transmits the mobile course to the mobile device before providing the on-line course.

Also disclosed is a method for integrating course data. A server provides at least one on-line course page to a receiver. The server transmits, according to a schedule, at least one mobile course page associated with the on-line course page in the form of text messages or multimedia messaging service (MMS) messages to the mobile device.

The on-line course page may comprise an on-line course. The mobile course page may comprise a mobile course. The method further comprises displaying the on-line course in a first region of an interface and a link referring to the mobile course in a second region of the interface. The server delivers the mobile course and plays the mobile course on the computer the mobile course when the receiver selects the link utilizing the computer.

The method further comprises associating the on-line course with the mobile course based on on-line course metadata of the on-line course and mobile course metadata of the mobile course.

Additionally disclosed is a method for integrating course data. An on-line course is composed by authoring or extracting an existing on-line course page. On-line course metadata of the on-line course is authored. A mobile course is composed by authoring or extracting an existing mobile course page. Mobile course metadata of the mobile course is authored. An integration rule is composed, describing corresponding elements of on-line course metadata and mobile course metadata. When the on-line course is displayed, the mobile course is located based on the on-line course metadata and the integration rule.

The disclosed method may be implemented in a program comprised in a storage medium. When the program is loaded into a machine, the machine executes the disclosed method.

### DESCRIPTION OF THE DRAWINGS

The invention can be more fully understood by reading the subsequent detailed description and examples with references made to the accompanying drawings, wherein:

FIG. 1 is a schematic diagram of an embodiment of a system for integrating on-line and mobile courses;

FIG. 2 is a schematic view showing an embodiment of a on-line and mobile course interface;

FIG. 3 is a flowchart of an embodiment of a method for integrating on-line and mobile courses;

FIG. 4A is an example of on-line course metadata;

FIG. 4B is an example of mobile course metadata;

FIG. 4C is an example of integration rules; and

FIG. 5 is a flowchart of an embodiment of a method for integrating on-line and mobile courses.

### DETAILED DESCRIPTION

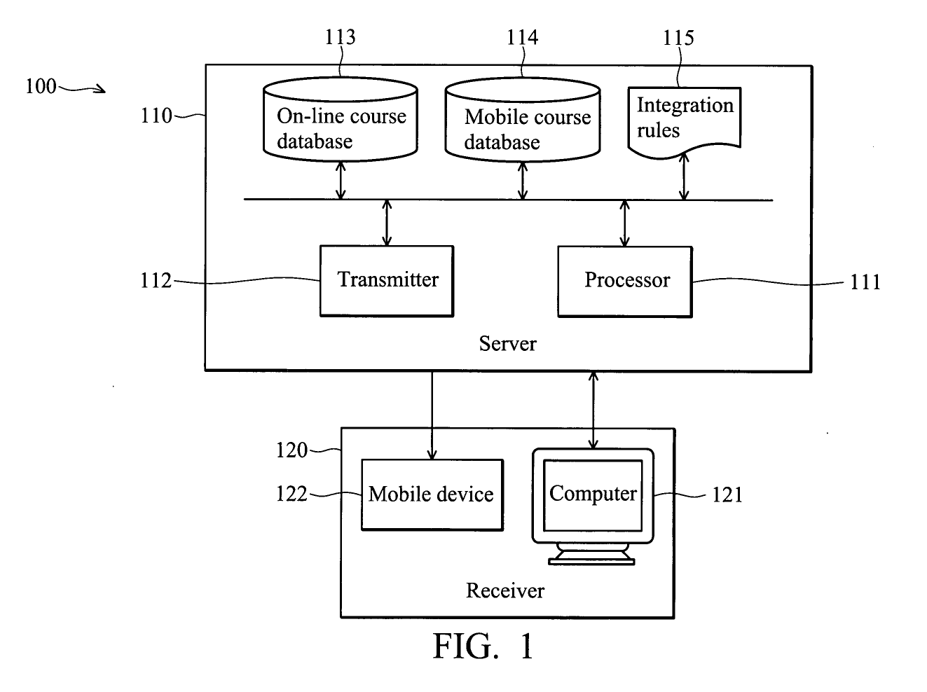

Systems and methods for integrating on-line and mobile course pages will be described in detail in the following. Said on-line and mobile course pages may respectively include on-line courses and mobile courses. Note that on-line course pages and the mobile course pages may include other content. In FIG. 1, system 100 for integrating on-line and mobile course pages comprises server 110 and receiver 120. Receiver 120 comprises computer 121 and mobile device 122, such as a mobile phone or a personal digital assistant (PDA).

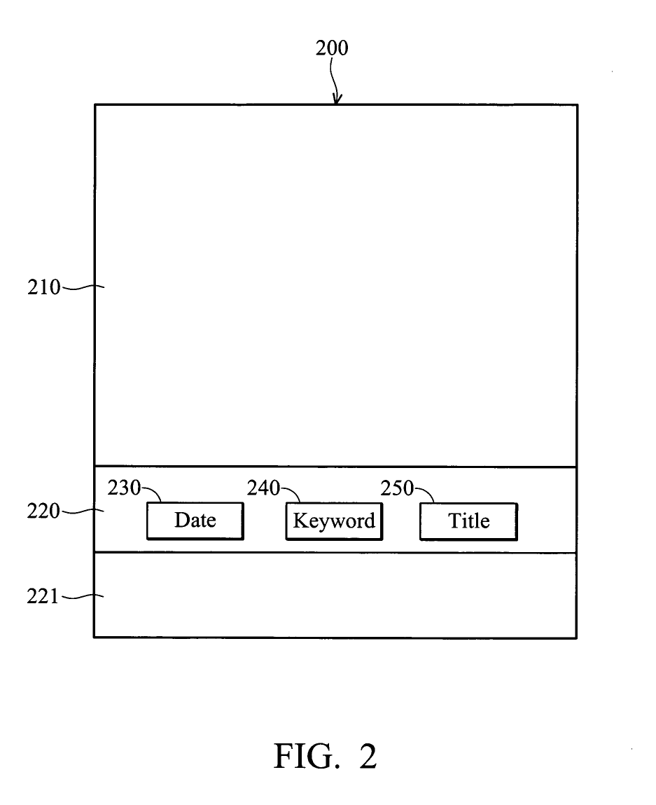

Server 110 comprises a processor 111, a transmitter 112, on-line course database 113, mobile course database 114, and integration rules 115. Processor 111 processes operations for server 110, including receiving requests from receiver 120 and responding accordingly. For example, processor 111 can provide on-line course pages from on-line course database 113 to receiver 120 for on-line learning via an interface. In an example, server 110 displays on-line courses in a first region 210 of interface 200 and displays links referring to mobile courses associated with the on-line courses in a second region 220 of interface 200, as shown in FIG. 2. First region 210 and second region 220 may be different frames of a window.

Note that the links to mobile courses can be classified into categories respectively corresponding to course date 230, keyword 240, or title 250. When a particular category is selected, links thereof are displayed in region 221. Additionally, when receiver 120 selects a link utilizing computer 121, server 110 can deliver a linked mobile course and play the mobile course on computer 121 of receiver 120 or transmit the mobile course to mobile device 122 utilizing transmitter 112. The mobile course is then played by a mobile course player (not shown in FIG. 1), such as a Java-implemented MMSClient player executed by a mobile phone. For example, a first frame may be an on-line course frame for displaying on-line course content of a certain chapter. A second frame may be a relevant mobile course frame for displaying mobile courses or other subjects associated with the chapter. A student can find mobile courses with the same course date based on correspondence of course date, keyword, or title. A method for integrating on-line and mobile course and integration rules 115 are described later.

Transmitter 112 can transmit mobile courses of mobile course database 114 in the form of a text message or Multimedia Messaging Service (MMS) messages to mobile device 122 of receiver 120 according to a schedule (not shown in FIG. 1). Receiver 120 can display the mobile courses accordingly. Note that the schedule for transmitting mobile courses may be determined based on course dates and times or other attributes. Transmitter 112 may be a radio signal transmitting module, such as a mobile phone or a base station of a telecommunication service provider.

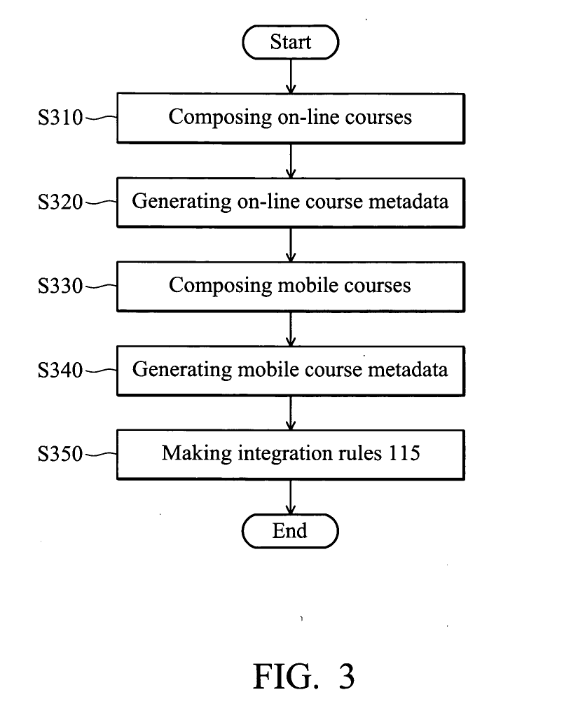

FIG. 3 is a flowchart of an exemplary embodiment of a method for integrating on-line and mobile course pages.

First, in step S310, an on-line course is composed by authoring on-line course pages or extracting existing on-line course pages. In step S320, on-line course metadata and actual course content are generated to facilitate correspondence of course content when the courses are displayed. In an example, on-line course metadata of an on-line course may be composed utilizing the Sharable Content Object Reference Model (SCORM), fields thereof are defined in the following Table 1.

TABLE 1

| Metadata fields (xpath) | Definition |
|---|---|
| general/title | Title of a course |
| general/catalogentry | Catalog of a course |
| general/keyword | Keywords in a course |
| general/date | Course date |

Next, in step S330, mobile courses are composed by authoring mobile course pages or extracting existing mobile course pages. In step S340, mobile course metadata and actual course content are generated to facilitate correspondence of course content when the courses are displayed. In an example, mobile course metadata of a mobile course may be composed utilizing extensible markup language (XML) and fields defined in the following table 2.

TABLE 2

| Metadata fields | Definition |
|---|---|
| title | Title of a course |
| catalogentry | Catalog of a course |
| keyword | Keywords in a course |
| date | Course date |

In step S350, integration rules 115 are made, describing correspondence of on-line course metadata and mobile course metadata for incorporating course presentation.

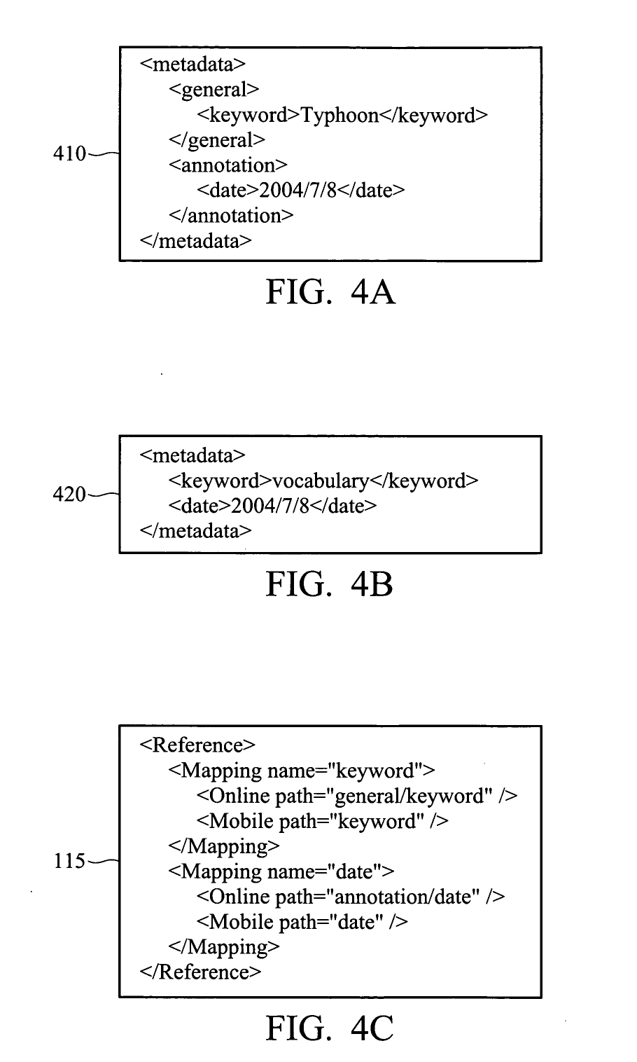

FIGS. 4A and 4B show on-line course metadata 410 and mobile course metadata 420 corresponding to Table 1 and Table 2 respectively. FIG. 4C shows exemplary integration rules 115. As shown in FIG. 4C, integration rules 115 state that fields corresponding to mapping name “keyword” comprise the on-line course metadata field “general/keyword” and mobile course metadata field “keyword” and, additionally, that fields corresponding to mapping name “date” comprise the on-line course metadata field “annotation/date” and mobile course metadata field “date”. When an on-line course is selected and displayed, mobile course database 114 is searched for the corresponding mobile course based on the on-line course metadata and integration rules 115.

Note that, in an example, on-line courses, on-line course metadata, integration rules, mobile courses corresponding to the on-line courses, and mobile course metadata may be integrated in advance into one or more files which may be stored in a database, such as on-line course database 113.

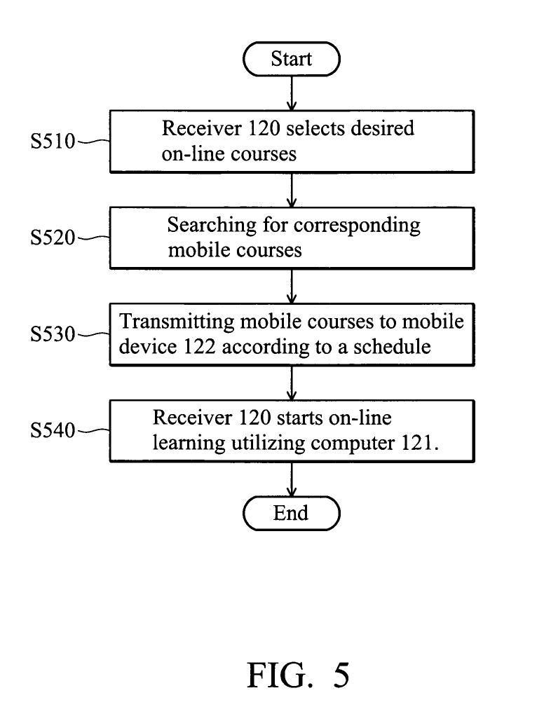

FIG. 5 is a flowchart of an embodiment of a method for integrating on-line and mobile courses.

First, in step S510, receiver 120 selects (or registers) desired on-line courses on server 110. Next, in step S520, on-line course database 113 searches for mobile courses associated with the on-line courses based on on-line course metadata of the selected on-line courses and integration rules 115. In step S530, server 110 transmits the located mobile courses of mobile course database 114 in form of text messages or MMS messages to mobile device 122 of receiver 120 according to a schedule. Receiver 120 starts mobile learning accordingly. Note that the schedule for transmitting mobile courses may be determined based on course dates and times or other attributes.

For example, when an on-line course is a linguistic course, mobile courses may comprise a portion of the linguistic course, such as a vocabulary word, a phrase, or a grammar concept, and the server 110 may transmit the mobile courses to mobile device 122 of receiver 120 before providing the on-line course to receiver 120. Thus, receiver 120 may preview the vocabulary, phrase, or grammar course content.

As step S540, receiver 120 can study the selected on-line courses on server 110 utilizing computer 121. Additionally, when the on-line courses are displayed, receiver 120 can select links to corresponding mobile courses. When the links are selected, server 110 can display the linked mobile courses on computer 121 of receiver 120 or transmit the mobile course to mobile device 122 utilizing transmitter 112. The mobile course is then played by a mobile course player. Server 110 may also transmit the mobile courses to mobile device 122 of receiver 120 after providing the on-line course to receiver 120 for on-line learning. Thus, the vocabulary, phrase, or grammar concept therein may be reviewed in receiver 120.

Hence, the disclosed system and method integrates on-line courses and mobile courses to improve on-line and mobile learning flexibility and efficiency. Mobiles courses need not be transformed to course pages, thus ameliorating consistency issues between course pages and messages. Additionally, no fixed links are added to on-line course source course pages, providing flexibility for future use. Further, time required for authoring is greatly reduced since integration does not require on-line courses to be authored again.

The disclosed method or some portions thereof may be implemented in a program comprised in a storage medium, such as floppy disk, disc, hard disk, or other machine-readable (such as computer-readable) storage media. When the program is loaded into a machine, such as a computer, the machine executes the disclosed method. The disclosed method or some portions thereof may be implemented in program codes which may be transferred in a transmission medium, such as cable, optical fiber, or others. When the program codes are received, loaded, and executed by a machine, the machine executes the disclosed method. A general-purpose processor associated with the program codes may provide operations to simulate a particular device designed with special logic.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for integrating course data, comprising:
a receiver comprising a computer and a mobile device; and
a server transmitting at least one on-line course page to the computer and transmitting at least one mobile course page associated with the on-line course page to the mobile device.

2. The system as claimed in claim 1, wherein the on-line course page comprises an on-line course, and the mobile course page comprises a mobile course.

3. The system as claimed in claim 2, wherein the receiver displays the on-line course in a first region of an interface and a link referring to the mobile course in a second region of the interface.

4. The system as claimed in claim 3, wherein the server enables the mobile course to be played when the receiver selects the link via the computer.

5. The system as claimed in claim 2, wherein the server further associates the on-line course with the mobile course based on metadata of the on-line course and metadata of the mobile course.

6. The system as claimed in claim 2, wherein the server further transmits the mobile course to the mobile device of the receiver according to a schedule.

7. The system as claimed in claim 2, wherein the on-line course comprises a linguistic course, the mobile course comprises at least a vocabulary, a phrase, or a grammar concept mentioned in the linguistic course, and the server transmits the mobile course to the mobile device before transmitting the on-line course.

8. The system as claimed in claim 2, wherein the mobile course is transmitted to the mobile device in form of a text message or a multimedia message.

9. A method for integrating course data, comprising:
providing, by a server, at least one on-line course page to a computer of a receiver;
transmitting, by the server, at least one mobile course page associated with the on-line course page to a mobile device of the receiver.

10. The method as claimed in claim 9, wherein the on-line course page comprises an on-line course, and the mobile course page comprises a mobile course.

11. The method as claimed in claim 10, further comprising displaying the on-line course in a first region of an interface and a link referring to the mobile course in a second region of the interface.

12. The method as claimed in claim 11, further comprising displaying the mobile course when the receiver selects the link utilizing the computer.

13. The method as claimed in claim 10, further comprising associating, by the server, the on-line course with the mobile course based on on-line course metadata of the on-line course and mobile course metadata of the mobile course.

14. The method as claimed in claim 10, further comprising transmitting, by the server, the mobile course to the mobile device of the receiver according to a schedule.

15. The method as claimed in claim 10, wherein the on-line course comprises a linguistic course, the mobile course comprises at least a vocabulary, a phrase, or a grammar concept mentioned in the linguistic course, and the method further comprising transmitting, by the server, the mobile course to the mobile device before providing the on-line course.

16. The method as claimed in claim 10, wherein the mobile course is transmitted to the mobile device in form of a text message or a multimedia message.

17. A method for integrating on-line course page, comprising:
composing an on-line course page;
authoring metadata of the on-line course page;
composing an mobile course page;
authoring metadata of the mobile course page;
composing an integration rule describing correspondence between on-line course metadata and mobile course metadata; and
when the on-line course page is displayed, searching the mobile course page based on the on-line course metadata and the integration rule.

18. The method as claimed in claim 17, wherein the on-line course page comprises an on-line course, and the mobile course page comprises a mobile course.
